(19) United States
(12) Patent Application Publication
(10) Pub. No.: US 2007/0051225 A1
(43) Pub. Date: Mar. 8, 2007

(54) Strap attachment device

(76) Inventor: Stefan Dapergolas, Windham, NH (US)

Correspondence Address: DAVIS & BUJOLD, P.L.L.C., 112 PLEASANT STREET, CONCORD, NH, 03301, US

(21) Appl. No.: 11/222,414

(22) Filed: Sep. 8, 2005

(51) Int. Cl. G10G 5/00; G10D 3/00

(52) U.S. Cl. 84/327

(57) ABSTRACT

A strap connector engaging an anchor cone having a cylindrical shaft and an outer cone having a narrower inner end with diameter Dmin and a wider outer end having diameter Dmax. The strap connector has a connector opening with an engagement port with a minor diameter less than Dmax aligned along an engagement axis and an orthogonally aligned major diameter at least equal to Dmax. A locking slot has a major length greater than Dmin aligned along a locking axis and an orthogonal minor width greater than Dmin. The cone section is passed through the engagement port in the tilted position and rotated and slid to engage the anchor port with the strap connector.

### FIELD OF THE INVENTION

The present invention relates to an attachment device for attaching a strap or strap-like object to another object and, in particular, to an attachment device for attaching a support strap to a music instrument such as a guitar.

### BACKGROUND OF THE INVENTION

Straps, that is, elongated pieces of material, such as cloth, leather, plastic, or any combination of such materials, are frequently used to attach one object to another for various purposes, such as fasteners on suitcases, briefcases, packs and satchels and the like. Straps are also commonly attached to objects to assist in carrying the objects or in supporting the objects, such as packs, briefcases and satchels, in a desired position. One very common use of such straps is to support musical instruments, such as guitars, in a preferred playing position to thereby leave both of the musicians hands free to play the instrument.

Support straps for objects such as musical instruments must, however, meet the unique requirements arising from and possibly peculiar to the typical methods of use of the objects. For example, one end of a guitar strap is attached to an upper anchor point typically located on the upper part of the guitar and passes over one of the musician's shoulders and across the musician's back to approximately waist level where the other end of the strap is attached to a lower anchor point on the guitar body, typically at the lowest point of the guitar body. The strap may be adjusted to support the guitar in the desired position by adjusting the length of the strap, typically by a conventional buckle or velcro connector located along the strap, and by moving the strap with respect to the musician's body.

A guitar strap is typically attached to the two anchor points on the guitar by attachment devices which permit the strap to be easily attached and removed for ease and convenience in using the guitar and for ease in replacing the strap when it becomes worn or dirty. Also, straps are often a matter of style, decoration and personal preference and may be changed as, for example, a musician acquires a better strap or as the musician's taste changes. It must also be noted that musicians differ as to how the strap is used when playing. That is, some musicians attach and detach the strap each time they take the guitar up or put it down, while others simply leave the strap attached at all times.

In summary, therefore, the attachment device used to attach a guitar strap to a guitar must meet a number of requirements. For example, the attachment device must attach the strap to the guitar in a secure, reliable manner and must do so over a significant range of angles between the strap and the guitar, must be easy to attach and detach, often repeatedly and at short intervals, must be durable, and must be reasonably pleasing in appearance, or at least unobtrusive.

The prior art has offered a number of possible solutions for a satisfactory strap attachment device, such as hooks, circular spring loaded “button” fasteners and buckle arrangements, none of which has been fully satisfactory. Probably the most popular and most often used are arrangements wherein an inverted cone shaped member is fastened to the guitar and engages the strap by fitting into and through a slit or slit and hole in the strap. In the cone and slit fastener, an inverted cone is attached to the object to which the strap is to be attached, so that the narrowest part of the cone, which will be referred to as the base of the cone, is adjacent to or at the object and so that the cone widens out to its maximum diameter at the end away from the object, which will be referred to as the “head” of the cone. The strap in turn includes a slit having a width narrower than the cone head diameter and approximately the same as or greater than the cone base diameter. The strap is attached to the object by passing the slit over the cone head, which is possible because the resiliency of the strap material allows the necessary deformation of the strap and slit. The strap and slit then move down towards the cone base and return to their normal configuration, with the slit closing around the narrower cone base. The resilience of the strap material, that is, the “springiness” of the strap material will then keep the slit closed around the cone base and will resist any force urging the strap and slit to slide upwards past the cone head.

The cone and slit attachment is often modified by making the slit narrower than the cone base and adding a hole of slightly larger diameter than the cone base at one end of the slit for the cone base to rest in when the strap is attached onto the cone fastener. This arrangement is considered more secure and more satisfactory than the simple slit arrangement because the cone base does not deform the slit or the material of the strap when it is resting in the hole and because it will take greater force to open the narrower slit sufficiently to pass the cone head.

In yet other variations of the cone and slit type fastener, a hole at one end of the slit is made a greater diameter than the cone head, so that the head passes through the larger end hole. The strap is then secured to the cone attachment by sliding cone the base of the cone along the slit, which is too narrow to pass the cone head, thus securing the strap to the cone. This attachment may be further modified by adding a second hole at the other end of the slit wherein the second hole fits and provides a resting place for the cone base.

Although widely used, the various types of cone and slit type attachments are not entirely satisfactory. For example, the slit and the strap material around the slit is very subject to wear and loosening over time and after a certain amount of wear the cone can easily slip out of the slit or hole. If the strap material is made thicker or stiffer, the same type of wear will occur, only not as rapidly, but the attachment is harder to use as it takes significantly more force to push the cone through the slit.

The cone and slit type of attachment has the further severe disadvantage of being least secure against any force exerted on the strap along the axis of the cone as forces along the cone axis will tend to most really move the slit and strap upward and off of the head of the cone. As such, the cone and slit type attachments are most secure against forces that act orthogonally to the cone axis as such forces tend to do no more than move the cone along the slit. The cone and slit type attachment with a hole at one end also has the disadvantage that any pressure along the direction of the slit can move the cone along the slit and to the hole so that the attachment can become undone.

Although the cone and slit types of attachment can be made of rigid material, thereby avoiding some of the problems of a slit type attachment formed in resilient material, the attachment can become detached even more easily as the rigid material requires that the slit be fitted over the head of the cone by means of a hole that must be at least the greatest diameter of the cone head. Also, the rigid material does not provide the resilient force fit type of engagement between the strap and cone that can be achieved with a strap or strap attachment made of resilient, flexible material. As such, and for example, the attachment can become detached any time the cone slides down to the large entry hole.

The present invention addresses and provides a solution for these and other related problems of the prior art.

### SUMMARY OF THE INVENTION

The present invention is directed to a strap, strap attachment and anchor cone for removably attaching a strap to an object wherein an anchor cone is mounted on the object the a strap connector is attached to the strap and releasably engages with the anchor cone.

According to the present invention, the anchor cone includes a cylindrical shaft section that is mountable to and extends outwards from the body of the object and a tapered cone section that extends coaxially outward from an outer end of the shaft section wherein the cone section has a narrower inner end having a diameter of Dmin and a wider outer end having a diameter of Dmax.

The strap connector has a connector opening that includes an engagement port and a locking slot. The engagement port is oriented along an engagement axis wherein the engagement port has a minor diameter less than Dmax aligned along the engagement axis and a major diameter at least equal to Dmax aligned orthogonally to the engagement axis. The locking slot is oriented along a locking axis and has a major length greater than Dmin that is aligned with the locking axis and a minor width greater than Dmin that is aligned orthogonally to the locking axis.

The anchor cone and engagement port may be rotated with respect to one another along a rotation axis orthogonal to the engagement axis, thereby reducing the projected diameter of the cone section on a plane of the engagement port to less than the minor diameter of the engagement port. The cone section may then be passed through the engagement port in the tilted position and rotated so that an axis of the cone section is perpendicular to the plane of the engagement port, whereupon the anchor cone may be slide into the locking slot to engage the anchor port with the strap connector.

### BRIEF DESCRIPTION OF THE DRAWINGS

The foregoing and other objects, features and advantages of the present invention will be apparent from the following description of the invention and embodiments thereof, as illustrated in the accompanying figures, wherein:

FIG. 1 is an illustration of an anchor cone and strap attachment of the present invention;

FIG. 2A is a side view diagram of an anchor cone;

FIG. 2B is a plane view of a strap attachment;

FIGS. 3A, 3B and 3C are diagrams illustrating geometric relationships of a strap attachment and anchor cone;

FIGS. 4A through 4D and 5 illustrate the operation of a strap attachment and an anchor cone; and,

FIG. 6 is a cross section view of a strap with strap attachment.

### DETAILED DESCRIPTION OF THE INVENTION

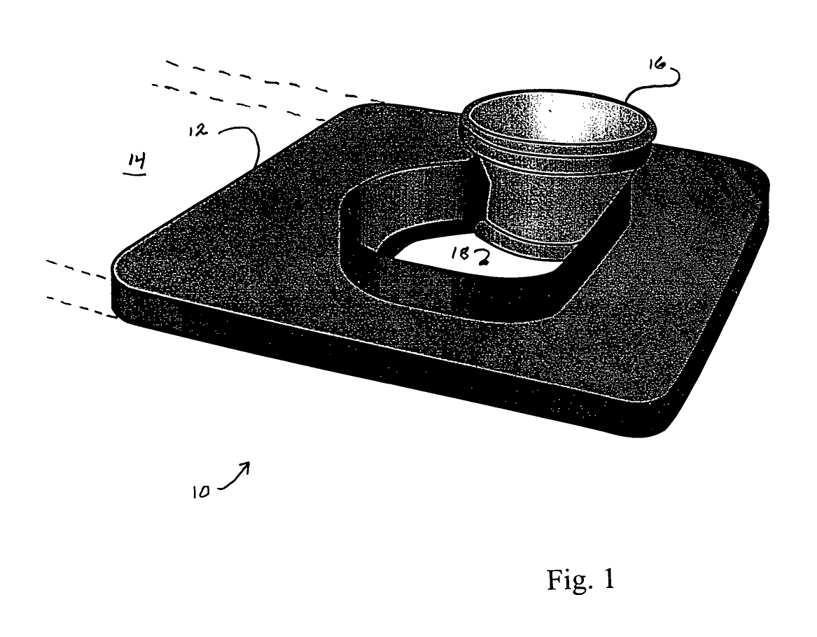

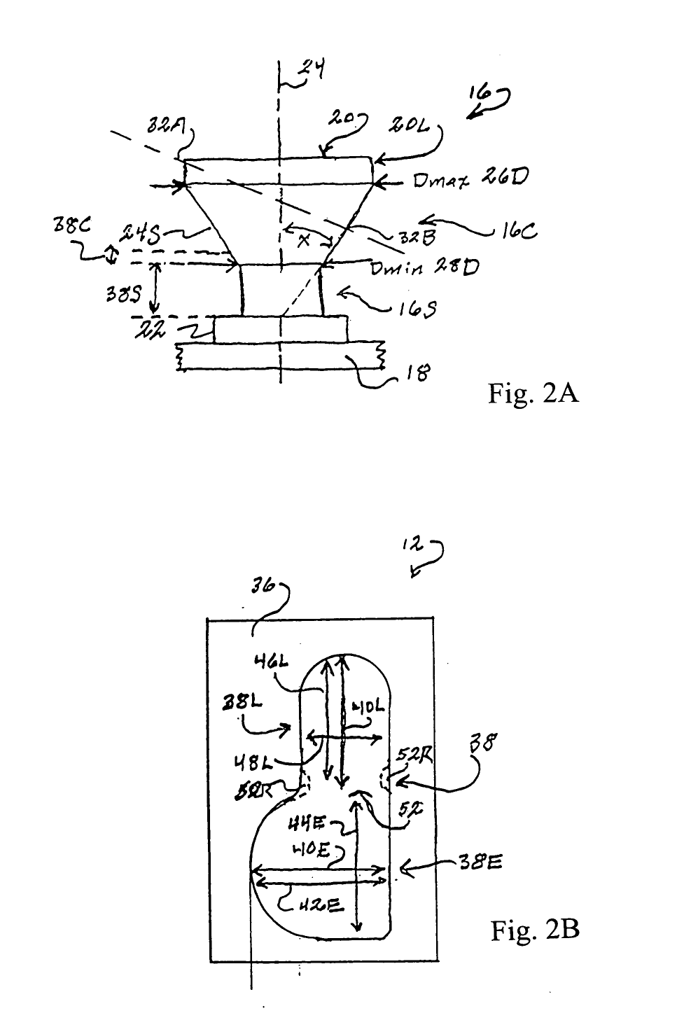

Referring to FIGS. 1, 2A and 2B, therein is illustrated an attachment device for attaching straps to objects and, in particular, for attaching a guitar strap to a guitar to support the guitar in a preferred playing position.

As has been described herein above, one end of a guitar strap is attached to an upper anchor point typically located on the guitar body and the strap passes over one of the musician's shoulders and across the musician's back to approximately waist level, where the other end of the strap is attached to a lower anchor point on the guitar body. The strap may be adjusted to support the guitar in the desired position by adjusting the length of the strap, typically by a conventional buckle or velcro connector located along the strap, and by moving the strap with respect to the musician's body. As also discussed, the strap attachments must attach the strap to the guitar in a secure, reliable manner and must do so over a significant range of angles between the strap and the guitar, must be easy to attach and detach, often repeatedly and at short intervals, must be durable, and must be reasonably pleasing in appearance, or at least unobtrusive.

As shown in FIGS. 1, 2A and 2B, a Strap Attachment 10 of the present invention includes a Strap Connector 12 that is mounted on the Strap 14 and that is attachable an Anchor Cone 16 mounted on the Body 18 of an object to which the Strap 14 is to be attached, such as a guitar body.

As illustrated in FIGS. 1, 2A and 2B, the primary elements of an Anchor Cone 16 include a tapered Cone Section 16C and a cylindrical Shaft Section 16S that connects with or is attached to or is a part of Cone Section 16C, with the inner end of Shaft Section 16S being attached or mounted to Body 18 and Cone Section 16 extending and expanding outwardly from the outer end of Shaft Section 16S. The diameter of Cone Section 16C is typically equal or approximately equal to the diameter of Shaft Section 16S at the intersection of Cone Section 16C and Shaft Section 16S, and the greatest diameter of Cone Section 16C is at the outer end of Cone Section 16C, that is, the end of Cone Section 16C most distant from Body 18.

The circumference of Outer End 20 of Cone Section 16C is designated in FIG. 2A as Lip 20L and may be of any of a variety of forms compatible with the function of Cone Section 16C, such as a flat-sided cylindrical section or a rounded lip. The end of Shaft Section 16S that abuts or is attached to the Body 18 is typically formed by a Base 22, which is typically cylindrical and of greater diameter than Shaft Section 16S and which is adapted for mounting Anchor Cone 16 to the Body 18, such as by a screw fastener.

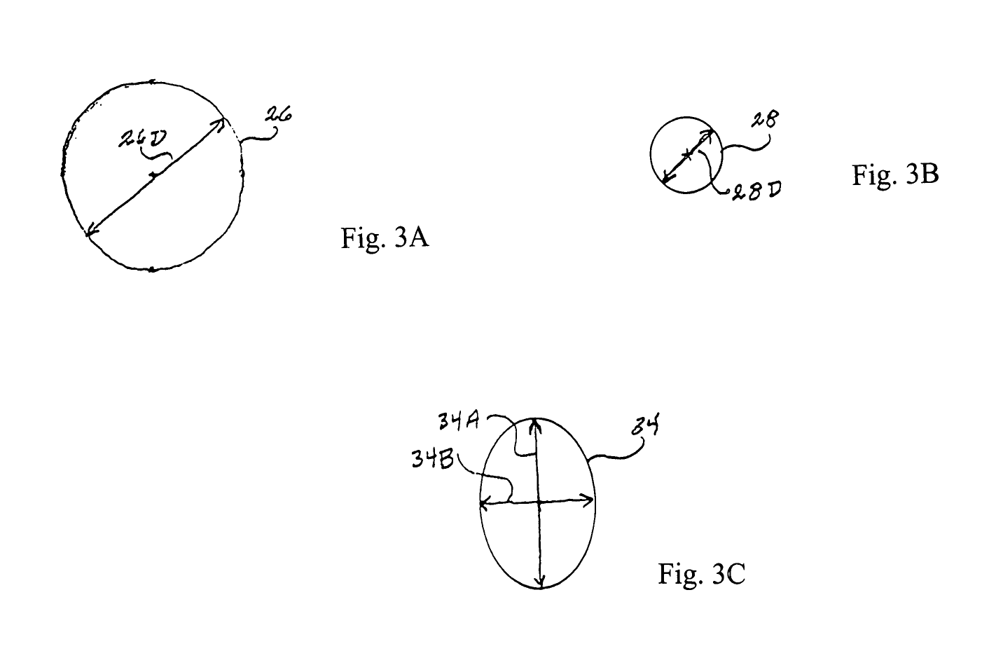

As illustrated in FIG. 2A, therefore, the Cone Section 16C has a maximum diameter of Dmax at the outer end of Cone Section 16C and a minimum diameter of Dmin at the inner end of Cone Section 16C, wherein Cone Section 16C meets Shaft Section 16S, as will Shaft Section 16S. A plane passing through the Cone Section 16C at the outer end of Cone Section 16C and at a right angle to Axis 24 of Cone Section 16C will thereby define a Max Circumference Circle 26 having a Diameter 26D of Dmax, as illustrated in FIG. 3A. In a like manner, a plane passing through the intersection of Cone Section 16C and Shaft Section 16S and at a right angle to Axis 24 will thereby define a Min Circumference Circle 28 having a diameter of Dmin 28D, as illustrated in FIG. 3B.

As also shown in FIG. 2A, the Side 24S of tapered Cone Section 16C is defined by an included Angle of Rotation 30 of X degrees about Axis 24 of Cone Section 16C. A plane passing through Cone Section 16C at an angle to Axis 24 and intersecting the widest diameter of Cone Section 16C at a Point 32A and Side 24S of Cone Section 16C at a Point 32B diametrically opposite Point 32B will define an Ellipse 34 having a Major Axis 34A and a Minor Axis 34B, as illustrated in FIG. 3C. As may be seen from FIGS. 2A and 3C, the length of Major Axis 34A approximately equal to or less than the Dmax 26D diameter of Max Circumference Circle 26. The length of Minor Axis 34B is dependent upon such factors as Dmax 26D and Dmin 28D, the angle at which the ellipse plane intersects Axis 24 and the included Angle of Rotation 30. It will be clear, however, that the length of Minor Axis 34B will be significantly less than the length of Major Axis 34A.

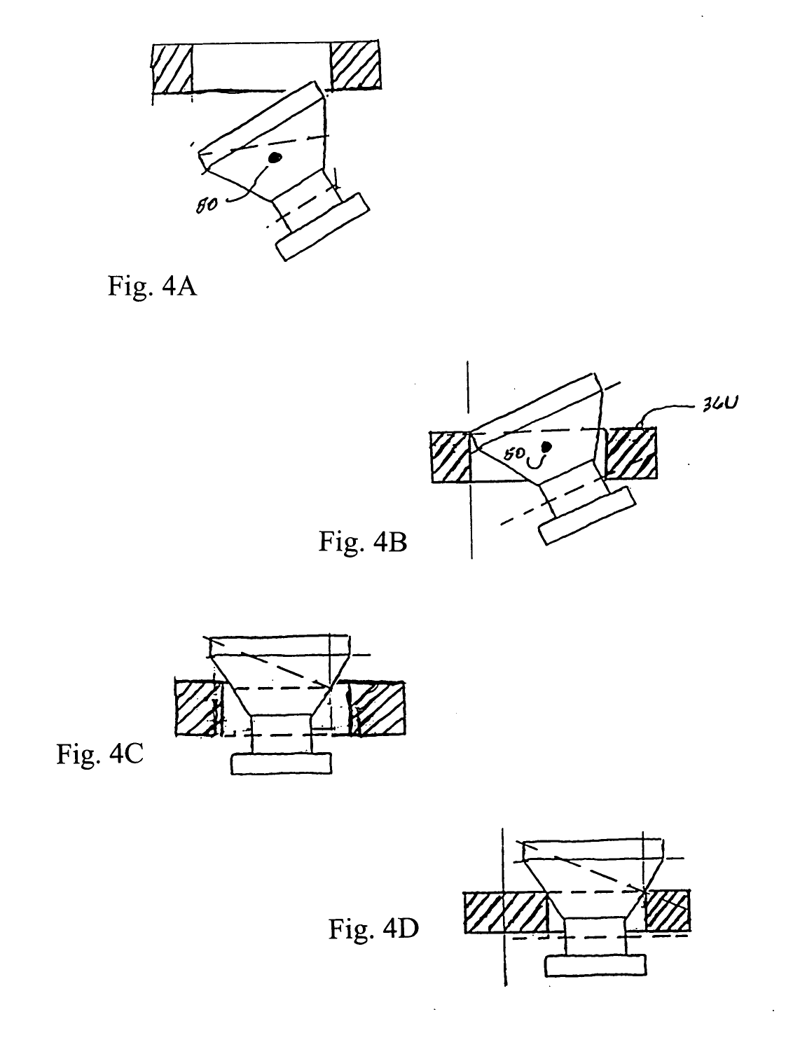

Referring now to FIG. 2B, Strap Connector 12 is formed of an essentially flat Connector Body 36 having a Connector Opening 38 there through. As may be seen from accompanying FIGS. 4A, 4B, 4C and 4D, the thickness of Connector Body 36 is approximately the Height 38S of Shaft Section 16S plus some portion, indicated as Height 38C, of Cone Section 16C of Anchor Cone 16, the specific dimensions depending in part upon the specific geometry of Anchor Cone 16.

Connector Opening 38, in turn, includes an Engagement Port 38E oriented along an Engagement Axis 40E and a Locking Slot 38L oriented along a Locking Axis 40L wherein Engagement Axis 40E is orthogonal to Locking Axis 40L and wherein Engagement Port 38E and Locking Slot 38L merge orthogonally to form the continuous, single Connector Opening 38. As described in further detail below, Engagement Port 38E is shaped and dimensioned to allow the entry of Cone Section 16C of an Anchor Cone 16 into Connector Opening 38 while Locking Slot 38L is shaped and dimensioned to receive and retain the Shaft Section 16S of the Anchor Cone 16.

The process of engaging an Anchor Cone 16 with a Strap Connector 12 to secure a Strap 14 to a Body 18, such as a guitar, is diagrammatically illustrated in FIGS. 4A-4D. Stated very briefly, and as will be discussed in further detail in a following description, this process is executed by passing Cone Section 16C into and through Engagement Port 38E, so that a major portion of Cone Section 16C is above the top of Strap Connector 12. Anchor Cone 16 is then slide sideways with respect to Strap Connector 12, that is, parallel to the plane of Strap Connector 12, to slide Shaft Section 16S of the Anchor Cone 16 into Locking Slot 38L to effectively lock the Anchor Cone 16 into Locking Slot 38L and thus to the Strap Connector 12.

It will be apparent that the relative shapes and dimensions of Cone Section 16C and Shaft Section 16S with respect to Engagement Port 38E and Locking Slot 38L are of major significance in the operation of the present invention. For example, Anchor Cone 16 will not be able to pass through Locking Slot 38L in the direction vertical to the plane of Strap Connector 12 because the width of Locking Slot 38L is only slightly larger than the diameter of Shaft Section 16S of the Anchor Cone 16. Engagement Port 38E, in turn, and as described in detail in the following, is likewise shaped and dimensioned with respect to Anchor Cone 16 so that the Cone Section 16C of the Anchor Cone 16 cannot accidentally or incidentally pass through Engagement Port 38E, but is shaped and dimensioned such that Cone Section 16C can pass through Engagement Port 38E if Cone Section 16C is intentionally positioned in a specific manner to do so.

The following will therefore describe the present invention with respect to the shapes and dimensions of Cone Section 16C and Shaft Section 16S with respect to Engagement Port 38E and Locking Slot 38L, and the resulting effects of these shapes and dimensions on the functioning of an Anchor Cone 16 and a Strap Connector 12. In this regard, it will be recognized that in most applications Anchor Cone 16 will be fixed to the body 18 of some object, such as a guitar. As such, the process of attaching a Strap 14 to the Body 18 is normally that of engaging the Strap Connector 12 with the Anchor Cone 16, rather than the reverse, although either method may be used. For purposes of simplicity in the following descriptions, however, the process will be described from the viewpoint of engaging the Anchor Cone 16 with the Strap Connector 12.

First considering the shape and dimensions of Engagement Port 38E, as indicated in FIG. 2B the dimensions of Engagement Port 38E are defined by a Minor Diameter 42E aligned along Engagement Axis 40E and a Major Diameter 44E aligned orthogonally to Engagement Axis 40E, with Major Diameter 44E typically being aligned parallel to Locking Axis 40L.

According to the present invention and as illustrated in FIGS. 4A, 4B, 4C and 4D, Major Diameter 44E of Engagement Port 38E is generally equal to or slightly greater than Dmax 26D, that is, the maximum diameter of the outer end of Cone Section 16C, while Minor Diameter 42E of the port is less than Dmax 26D. As a result, when Anchor Cone 16 is aligned with Axis 24 perpendicular to the plane of Engagement Port 38E, the outer end of Cone Section 16C cannot pass through Engagement Port 38E because the projected diameter of Cone Section 16C in the plane of Engagement Port 38E is Dmax 26D, which is greater than Minor Diameter 42E.

This relationship is illustrated in FIG. 4C, wherein it is shown that the outer end of Cone Section 16C, Dmax 26D, is of too great a diameter to pass through Engagement Port 38E when Axis 24 is perpendicular to the plane of Engagement Port 38E. It will be noted that FIG. 4C illustrates this relationship for the state when Cone Section 38C has been passed through Engagement Port 38E and is oriented with Axis 24 perpendicular to the plane of Engagement Port 38E, so that Anchor Cone 16 cannot unintentionally disengage from Strap Connector 12 by slipping through Engagement Port 38E. It will be understood, however, that this state will also exist before Cone Section 16C is passed through Engagement Port 38E, that is, before the start of the process to engage the Anchor Cone 16 with the Strap Connector 12, and in fact at any time the Axis 24 is perpendicular to the plane of Engagement Port 38E.

To engage Anchor Cone 16C with Strap Connector 12, and as illustrated in FIG. 4B, Anchor Cone 16 is rotated about an Axis 50 perpendicular to Engagement Axis 40E, that is, about an Axis 50 generally parallel to Locking Axis 40L. When Anchor Cone 16 is so rotated, the projected cross sectional shape and dimensions of Cone Section 16C with respect to the plane of Engagement Port 38E will assume the shape and dimensions of Ellipse 34 as illustrated in FIG. 3C. As described above, Ellipse 34 has a Major Axis 34A having a length approximately equal to or less than the Dmax 26D and a Minor Axis 34B having a length dependent upon such factors as Dmax 26D and Dmin 28D, the angle at which the ellipse plane intersects Axis 24 and the included Angle of Rotation 30, but that is significantly less than Dmax 26D.

As illustrated in FIG. 4B, the reduction in the projected cross sectional shape and dimensions of Cone Section 16C with respect to the plane of Engagement Port 38E due to the tilted orientation of Cone Section 16C with respect to the plane of Engagement Port 38E is sufficient to allow Cone Section 16C to pass through Engagement Port 38E. That is, the effective projected diameter of Cone Section 16C along Engagement Axis 40E at the plane of Engagement Port 38E becomes less than Minor Diameter 42E when Anchor Cone 16 is tilted in the manner shown in FIG. 4B. As previously discussed, the effectively projected diameter of Cone Section 16C orthogonally to Engagement Axis 40E at the plane of Engagement Port 38E is equal to or slightly greater than Dmax 26D whether Anchor Cone 16 is tilted or not.

As also indicated in FIG. 4B, the dimensions of Anchor Cone 16, the thickness of Connector Body 36 and the dimensions of Engagement Port 38E are chosen so that at least a portion of the circumference of Outer End 20 of Cone Section 16C, that is, a portion of Lip 20L, will reach a point at or above the Upper Surface 36U of Connector body 36

At this point, Anchor Cone 16 may be rotated so that Axis 24 moves back to the vertical position and so that the remaining portions of Cone Section 16C are rotated upward through Engagement Port 38E so that the major part of Cone Section 16C is positioned above Upper Surface 36U of Connector Body 36, as illustrated in FIG. 4C.

It will be apparent from the above discussions that the Dmax 26D and Dmin 28D, the height of Cone Section 16C, and the angle of rotation of Cone Section 16C and the height of Shaft Section 16S are all significant factors in determining the operation of Strap Attachment 10 and the dimensions of Strap Connector 12 and, in particular, of Engagement Port 38E and Locking Slot 38L. It will also be apparent that these dimensions may vary widely in different embodiment of a Strap Attachment 10, but that these dimensions are readily determined using ordinary geometric methods that are well known to those of ordinary skill in the art. As such, the determination of the specific dimensions for these elements will not be discussed in further detail herein.

As illustrated in FIG. 4D, Anchor Cone 16 is then locked into engagement with Strap Connector 12 by sliding Anchor Cone 16 sideways with respect to Strap Connector 12, that is, parallel to the plane of Strap Connector 12, to slide Shaft Section 16S of the Anchor Cone 16 into Locking Slot 38L to effectively lock the Anchor Cone 16 into Locking Slot 38L and thus to the Strap Connector 12.

In this regard, it will be apparent that the engagement of Anchor Cone 16 into Locking Slot 38L is dependent upon the dimensions of Locking Slot 38L, which for purposes of the present invention is defined by a Major Length 46L aligned along Locking Axis 40L and a Minor Width 48L aligned orthogonally to Locking Axis 40L. As illustrated in FIG. 4C, Minor Width 48L is equal to or somewhat greater than Dmin 28D 28 to allow Shaft Section 16S and possibly some portion of the lower part of Cone Section 16C to move along Locking Axis 40L to enter and reside within Locking Slot 38L. In a like manner, the length of Major Length 46L, in turn, is greater than Dmin 28D to allow Shaft Section 16S and possibly some portion of the lower part of Cone Section 16C to be contained entirely within Locking Slot 38L.

In this regard, and because it is intended that the Shaft Section 16S of an Anchor Cone 16 should be retained in the Locking Slot 38L, the Minor Width 48L may be reduced to be equal to or somewhat less than the diameter of the Shaft Section 16S in Entry 52 of Locking Slot 38L, that is, in the region of Locking Slot 38L that adjoins Engagement Port 38E and through which the Shaft Section 16S enters the Locking Slot 38L. In one embodiment, illustrated by way of example in FIG. 2B, Entry 52 is narrowed in this manner by one or more Retainers 52R which extend into Entry 52 to narrow Entry 52 to less than the diameter of the Shaft Section 16S. The extension of the Retainer 52R or Retainers 52R is chosen to providing a frictional interference fit that will retain the Shaft Section 16S in Locking Slot 38L but which will allow the Shaft Section 16S to pass through the narrowed section by the exertion of moderate additional force. For this reason, the Retainer 52R or Retainers 52R are typically faired into the sides of Engagement Port 38E and Locking Slot 38L to form a sliding surface.

It will also be noted in FIGS. 1 and 2B that Locking Axis 40L is represented as being oriented orthogonally, that is, generally at a right angle, to Engagement Axis 40E. This exemplary embodiment illustrates the well known fact that when a strap is used to suspend or support or fasten an object, such as suspending a guitar from the shoulder of the player, there will be a resulting force exerted along the axis of the strap that will tend, or at least attempt, to separate or detach the Strap Connector 12 from the Anchor Cone 16.

As such, it is preferable that at least Locking Slot 38L be oriented so that the forces normally exerted on the Strap 14 will preferably not be exerted along Locking Axis 40L in such a manner as to pull Anchor Cone 16 out of Locking Slot 38L. In the example shown, therefore, the Strap 14, Strap Connector 12 and Locking Slot 38L would be oriented so that in normal use the forces would be exerted along Locking Slot 38L in the direction away from Engagement Port 38E, that is, so as to force Anchor Cone 16 deeper into Locking Slot 38L.

Engagement Axis 40E of Engagement Port 38E as illustrated in FIG. 2B is oriented with respect to Locking Slot 38L in accordance with the same considerations and in accordance with the consideration that Engagement Axis 40E is preferably not be aligned with Locking Slot 38L so that a force that would pull Anchor Cone 16 out of Locking Slot 38L would not move Anchor Cone 16 directly into Engagement Port 38E, thereby providing another opportunity to prevent the unwanted disengagement of Strap Connector 12 from Anchor Cone 16. It should be noted, however, that it is not necessary that Engagement Axis 40E be oriented at a right angle to Locking Slot 38L. For example, the angle between Engagement Axis 40E and Locking Slot 38L may be less than or greater than 90 degrees, depending upon a given situation and requirements and with appropriate adjustments in the geometry and dimensions of the elements of Strap Connector 12 and Anchor Cone 16.

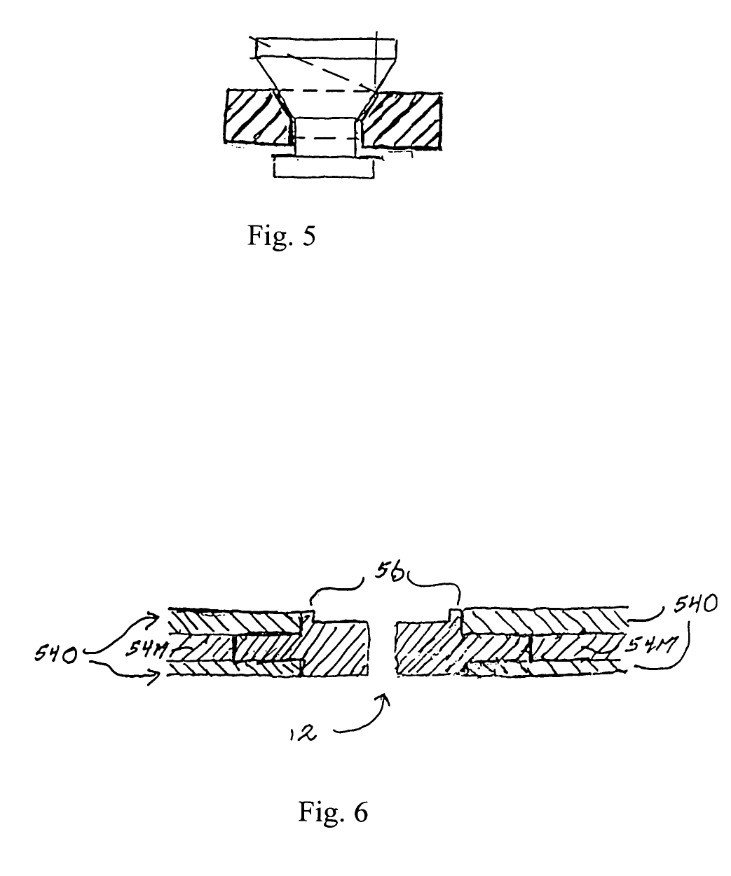

In further embodiments of the present invention, as illustrated in FIG. 5, the inner edges of Body 36 of Strap Connector 12 may be beveled at Upper Surface 36 and around the periphery of Engagement Port 38E or of Engagement Port 38E and Locking Slot 38L. This beveling would have the effect of reducing the thickness of Body 36 in these areas and of matching the upper edges of Engagement Port 38E and Locking Slot 38L to the taper of Cone Section 16S. The beveling would thereby allow Cone Section 16S to more easily rotate through Engagement Port 38E, even if the dimensions of Engagement Port 38E were reduced to provide a more secure fastening. The beveling would also provide a greater bearing surface between Surface 24S of Cone Section 16S and Body 36, again providing a more secure fastening and reducing the chances of wear or tearing of the material comprising Strap Connector 12.

Strap Connector 12 and a Strap 14 may also vary in the manner in which the Strap Connector 12 is mounted to the Strap 14. For example, and as illustrated in FIG. 6A, Strap Connector 12 may be secured into a matching opening in the Strap 12, leaving the Upper Surface 36U of Body 36 visible.

In other embodiments, such as are illustrated in FIGS. 6B and 6C, the Strap 12 may be comprised of a multi-layer material, shown herein as a Middle Layer 54M and two Outside Layers 54O. Strap Connector 12 may then be embedded in an matching opening in Middle Layer 54M and accessible through openings in Outer Layers 54O that are sized and shaped to match Connector Opening 38. In this embodiment, the Connector Opening 38 would typically be provided with a surrounding Rim 56 to protect the edges of the openings in Outer Layers 54O around the Connector Opening 38. This embodiment may be further modified by cutting back the opening the Outer Layer 54O around the Connector Opening 38 by a clearance space for Base 22 of the Anchor Cone 16.

In a presently preferred embodiment, Anchor Cone 16 is comprised of brass or other metals, including plated metals, and is mounted to Body 18 by #6 countersunk Philips oval head screws. The dimensions of the various elements of Anchor Cone 16 may typically be in the range of 12-14 mm. Strap Connector 12 may in turn be comprised of any of a range of plastics or metals and the dimensions of a Strap Connector 12 may typically be in the range of 12.40 to 12.50 mm. Lastly, a Strap 14 may be comprised of leather, suede or synthetic fibers or materials and, in a presently preferred embodiment is comprised of a multi-layer material comprised of synthetic material, leather and suede. It should also be noted that a Strap 14 may be made in a number of alternate ways so long as the resulting Strap 14 meets the user's requirements. For example, current molding methods allow an object to be molded of a single material having characteristics that controllably vary throughout the body of the objects. As such, a Strap Connector 12 or Connectors 12 may be molded as a part or parts of a single piece Strap 14 body rather than being inserts into a multi-layer Strap 14 assembly. In this implementation, for example, the Strap Connector 12 portion or portions of the strap body are comprised of regions of the material having greater hardness and the strap portion or portions of the body are comprised of the same material, but with more flexible characteristics. The desired Outside Layers 54O may then be attached to the molded Strap 14 body with the integral Strap Connectors 12.

Since certain changes may be made in the above described method and system without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A strap attachment for removably attaching a strap to an object, comprising:
an anchor cone mounted on the object, and
a strap connector attached to the strap and releasably engaging with the anchor cone,
the anchor cone including
a cylindrical shaft section mountable to and extending outwards from the body, and
a tapered cone section extending coaxially outward from an outer end of the shaft section with a narrower inner end having a diameter of Dmin and a wider outer end having a diameter of Dmax, and
the strap connector having a connector opening, including
an engagement port oriented along an engagement axis and having a minor diameter less than Dmax aligned along the engagement axis and a major diameter at least equal to Dmax aligned orthogonally to the engagement axis, and
a locking slot oriented along a locking axis and having a major length greater than Dmin aligned with the locking axis and a minor width greater than Dmin aligned orthogonally to the locking axis, whereby
the anchor cone and engagement port may be rotated with respect to one another along a rotation axis orthogonal to the engagement axis, thereby reducing the projected diameter of the cone section on a plane of the engagement port to less than the minor diameter of the engagement port,
the cone section may be passed through the engagement port in the tilted position and rotated so that an axis of the cone section is perpendicular to the plane of the engagement port, and
the anchor cone is slid into the locking slot to engage the anchor port with the strap connector.

2. A strap removably attachable to an object having an anchor cone mounted thereon, the anchor cone including a cylindrical shaft section mountable to and extending outwards from the body and a tapered cone section extending coaxially outward from an outer end of the shaft section with a narrower inner end having a diameter of Dmin and a wider outer end having a diameter of Dmax, the strap comprising:
a strap body, and
a strap connector having a connector opening, the connector opening including
an engagement port oriented along an engagement axis and having a minor diameter less than Dmax aligned along the engagement axis and a major diameter at least equal to Dmax aligned orthogonally to the engagement axis, and
a locking slot oriented along a locking axis and having a major length greater than Dmin aligned with the locking axis and a minor width greater than Dmin aligned orthogonally to the locking axis, whereby
the anchor cone and engagement port may be rotated with respect to one another along a rotation axis orthogonal to the engagement axis, thereby reducing the projected diameter of the cone section on a plane of the engagement port to less than the minor diameter of the engagement port,
the cone section may be passed through the engagement port in the tilted position and rotated so that an axis of the cone section is perpendicular to the plane of the engagement port, and
the anchor cone is slid into the locking slot to engage the anchor port with the strap connector.

3. An anchor cone mounting to a body for removably attaching a strap to an object, the strap including strap connector having a connector opening including an engagement port oriented along an engagement axis and having a minor diameter less than Dmax aligned along the engagement axis and a major diameter at least equal to Dmax aligned orthogonally to the engagement axis and a locking slot oriented along a locking axis and having a major length greater than Dmin aligned with the locking axis and a minor width greater than Dmin aligned orthogonally to the locking axis, the anchor cone comprising:
a cylindrical shaft section mountable to and extending outwards from the body, and
a tapered cone section extending coaxially outward from an outer end of the shaft section with a narrower inner end having a diameter of Dmin and a wider outer end having a diameter of Dmax, whereby
the anchor cone and engagement port may be rotated with respect to one another along a rotation axis orthogonal to the engagement axis, thereby reducing the projected diameter of the cone section on a plane of the engagement port to less than the minor diameter of the engagement port,
the cone section may be passed through the engagement port in the tilted position and rotated so that an axis of the cone section is perpendicular to the plane of the engagement port, and
the anchor cone is slid into the locking slot to engage the anchor port with the strap connector.
